(19) United States
(12) Patent Application Publication
(10) Pub. No.: US 2004/0196313 A1
(43) Pub. Date: Oct. 7, 2004

(54) Ink repurposing

(75) Inventors: Roger Wynn, Redmond, WA (US); Kevin P. Paulson, Redmond, WA (US); Marieke Iwema, Seattle, WA (US); Shawna Swanson, Issaquah, WA (US); Greg Manto, Sammamish, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/372,862

(22) Filed: Feb. 26, 2003

(51) Int. Cl. G09G 5/00; G06K 9/00; G06F 15/00; G06F 3/02; G06F 17/21

(52) U.S. Cl. 345/779; 382/187; 345/179; 345/864; 345/810; 345/780

(57) ABSTRACT

Pen-based computing systems enable users to create, save, edit, modify, and manipulate electronic ink in various ways. To make such systems more useful, the electronic ink may be “repurposed” for use in other application programs. For example, pen-based computing systems may be programmed to: receive electronic ink data in a first application program and introduce a data set relating to at least a portion of the electronic ink data into a second, different application program. The data set introduced into the second application program may include electronic ink data or machine-generated text based on the electronic ink data. Users may freely select the electronic ink data to be transferred to the second application program and the application program to which the ink data will be transferred. The first application program, which serves as the source for the ink data to be transferred, may in some examples receive strokes as user input and generate electronic ink data from this user input (e.g., such as a document program in a pen-based computing system or tablet PC). The second application program, which serves as the target program for the ink data transfer, may be any suitable program into which transfer of ink data is desired, such as an email application program, an electronic calendar system, an electronic address book, an electronic task manager, a Web-browser, and the like.

### FIELD OF THE INVENTION

The present invention relates generally to systems, methods, and computer-readable media that allow for “repurposing” of electronic ink data. Such repurposing of ink may include transferring ink from an application program in which it may be created, stored, edited, modified, uploaded, or otherwise introduced to another, different application program in which the ink is used. For example, in accordance with examples of this invention, ink may be transferred from an ink entry application program (such as Windows Journal or the like) into an email application program, an electronic calendar program, an electronic task manager program, an electronic address book, or the like.

### BACKGROUND

Pen-based and stylus-based computing systems, such as tablet PCs, are increasing in popularity. Such systems are popular, at least in part, because of the very easy ways users can enter information into the systems and generate electronic documents that contain handwritten electronic ink. Such pen-based and stylus-based computing systems are particularly popular with and advantageous for certain classes of users, such as users who are unable and/or unwilling to type, users who attend meetings in which the clicking of a keyboard would be disruptive and/or unwelcome, as well as others. For many, the recently increased availability and enhanced performance associated with newly available pen-based and stylus-based computing systems have been welcomed advances.

Despite recent improvements in pen-based and stylus-based computing systems, particularly with respect to the input and processing of electronic ink, such computing systems and electronic ink have certain limitations. For example, input data in the form of electronic ink (e.g., from an application program that accepts electronic ink input) does not transfer well into other types of application programs. In many instances, electronic ink is pasted into other application programs, if at all, as large bitmap images that are difficult to edit, move, manipulate, or otherwise handle in the new application program in which it resides. Moreover, many application programs, such as email application program systems, electronic calendars, electronic address books, electronic task managers and the like, are not capable of accepting input in the form of electronic ink.

Accordingly, there is a need in the art for systems, methods, and computer-readable media that allow electronic ink input from electronic ink document application programs to become more flexible for ready use in other application programs, such as email application programs, electronic calendar application programs, electronic address book application programs, electronic task management application programs, and the like.

### SUMMARY

Aspects of the present invention relate to systems, methods, and computer-readable media programmed with instructions to perform methods that include: receiving electronic ink data in a first application program; and introducing a data set relating to at least a portion of the electronic ink data into a second application program that is different from the first application program. The data set introduced into the second application program may include electronic ink data or machine-generated text based on the electronic ink data. Users may freely select the electronic ink data to be transferred to the second application program and the application program to which the electronic ink data will be transferred. The first application program, which serves as the source for the ink data to be transferred, may receive strokes as user input and generate electronic ink data from this user input (e.g., such as a document program, like Windows Journal, in a pen-based computing system or a tablet PC). The second application program, which serves as the target program for the electronic ink data transfer, may be any suitable program into which transfer of electronic ink data is desired, such as an email application program, an electronic calendar system, an electronic address book, an electronic task manager, and the like.

Additional aspects of this invention relate to systems, methods, and computer-readable media for repurposing data from a first application program (“original data”) into data suitable for use in a different application (“repurposed data”), and associating additional information with the original data and/or the repurposed data. For example, when repurposing is accomplished, linking information, related data information, and/or metadata may be associated with the original data and/or the repurposed data. This linking information, related data information, and/or metadata may be useful, for example, to create and maintain a relationship between the original data and the repurposed data and/or to create and maintain a relationship to other data and information stored on the system. The additional information associated with the original data and/or the repurposed data also may enable users to easily search for and locate information on the computer system or network that is related to or otherwise associated with the original data and/or the repurposed data.

### BRIEF DESCRIPTION OF THE DRAWINGS

The above and other objects, features, and advantages of the present invention will be readily apparent and fully understood from the following detailed description, considered in connection with the appended drawings, which include:

FIG. 1, which illustrates an example display screen including electronic ink thereon as it may appear in some examples of the invention;

FIG. 2, which illustrates various optional “edit” operations that may be performed in an electronic document containing ink in systems and methods according to some examples of the invention;

FIG. 3, which illustrates various optional “convert to” operations that may be performed in systems and methods according to some examples of the invention;

FIGS. 4a-4e, which illustrate example conversions or repurposing of electronic ink text to e-mail messages;

FIGS. 5a-5c, which illustrate an example conversion or repurposing of electronic ink text to an electronic appointment book or calendar entry;

FIGS. 6a-6c, which illustrate an example conversion or repurposing of electronic ink text to an electronic address book or contact entry;

FIGS. 7a-7c, which illustrate an example conversion or repurposing of electronic ink text to an electronic task manager entry;

FIGS. 8a and 8b, which schematically illustrate systems and methods useful in the repurposing procedure.

FIG. 9, which illustrates a schematic diagram of a conventional general-purpose digital computing environment in which one or more examples of the present invention may be implemented; and

FIG. 10, which illustrates a pen-based personal computing (PC) environment in which one or more examples of the present invention may be implemented.

### DETAILED DESCRIPTION

As described above, the present invention relates to systems, methods, and computer-readable media that allow electronic ink data from an ink document application program to be converted or “repurposed” for use in other application programs, such as e-mail programs, electronic calendars, address books, task manager programs, and the like. The invention is described in more detail below.

The following description is divided into sub-sections to assist the reader. The sub-sections include: Terms, Ink Repurposing in General, Example Systems and Methods Relating to Ink Repurposing, Example Hardware, and Conclusion.

I. Terms

Ink—A sequence or set of one or more handwritten strokes. A sequence of strokes may include one or more strokes in an ordered form. The sequence may be ordered, for example, by the time the stroke was captured or by where the strokes appear on a page, on a digitizer screen, or in a document. Other orders also are possible. A set of strokes may include one or more sequences of strokes or unordered strokes or any combination thereof. The ink may further include properties that may be defined for the strokes, such as bolding, highlighting, color, etc.

Stroke—A sequence or set of one or more captured points. For example, when rendered, the sequence of points may be connected with lines. Alternatively, a stroke may be represented as a point and a vector in the direction of the next point. Further, a stroke may be referred to as a data structure containing a simple list (or array or table) of points. In short, a stroke is intended to encompass any representation of points or segments relating to ink, irrespective of the underlying representation of points and/or what connects the points.

Point—Information defining a location in space. For example, a point may be defined relative to a capturing space (for example, points on a digitizer) and/or a display space (the points or pixels of a display device). Points may be represented using a variety of known techniques including two dimensional Cartesian coordinates (X, Y), polar coordinates (r, Θ), three dimensional coordinates ((X, Y, Z), (r, Θ, ρ), (X, Y, t (where t is time)), (r, Θ, t)), four dimensional coordinates ((X, Y, Z, t) and (r, Θ, ρ, t)), and other techniques as known in the art.

Render—The process of determining how graphics, machine-generated elements, and/or ink are to be displayed, whether on a screen, printed, or output in some other manner.

Repurpose or Repurposing—Transferring ink or other data from an application program in which it may be created, stored, edited, modified, uploaded, or otherwise introduced to another, different application program. For example, ink or other data may be transferred from a source application program in which it is created, edited, and stored to a target application program selected from the group consisting of an email application program, an electronic calendar program, an electronic task manager program, an electronic address book, or the like. In repurposing ink, as one example, the ink may be converted to machine-generated text, or it may remain as electronic ink stroke data.

II. Ink Repurposing in General

As described above, some examples of this invention relate to systems and methods that allow for “repurposing” of electronic ink. The electronic ink data may be exported to other application programs to create personal information manager items, or “PIM” items, such as a calendar entry, an address book entry, an email message, a task manager entry, and the like. Such systems and methods may include: receiving electronic ink data in a first application program, and introducing a data set relating to at least a portion of the electronic ink data into a second application program that is different from the first application program, e.g., using a computer processor. The data set introduced into the second application program may include the actual portion of the electronic ink data (i.e., the data set introduced allows the data to appear as ink strokes in the second application program), or it may include data representing machine-generated text generated based on the portion of the electronic ink data.

In accordance with examples of this invention, the first application program may be a program that receives ink strokes as user input and generates electronic ink data from the user input (such as Windows Journal for Tablet PCs or the like). The second application program may be any suitable program where ink data or machine-generated text based on ink data may be useful, such as an email application program, an electronic calendar system (also called an electronic “appointment book” or “scheduling system” and the like), an electronic address book (also called a “contact” list), an electronic task manager, an Internet web browser application program, and the like.

Systems and methods according to examples of the invention also may include displaying a list of potential target second application programs to which the data set corresponding to the portion of the electronic ink may be introduced. This may be accomplished via a computer screen or other suitable user interface display device without departing from the invention. Additionally, systems and methods according to examples of this invention may include the ability for the system to receive input indicating a selection of the second application program (e.g., from a target application program listing provided as discussed above). As another potential feature, systems and methods according to examples of the invention may include the ability to receive input indicating a selection of the ink data to be transferred to the second application program. Any appropriate user input devices may be used for these purposes without departing from the invention, including but not necessarily limited to the specific user input devices described in more detail below.

Aspects of this invention also relate to computer-readable media including computer-executable instructions stored thereon for performing various methods according to the invention, such as the methods described above.

In some examples of systems, methods, and computer-readable media according to the invention, when original ink or other data is repurposed (e.g., moved from one application program to another), information relating to this ink or other data may be lost when the transfer occurs. For example, in some instances, no “historical” information is stored in the target application program along with the repurposed ink or other data to indicate that this portion of the data in the target application program originated from another application program. Additionally, in some instances, the source application program from which the original ink or other data was obtained contains no additional information to indicate that certain data in the source application was moved to another application.

In accordance with some examples of the invention, however, additional useful information may be associated with the original data and/or the repurposed data. For example, additional information may be stored in the source application program and/or in the target application program to create and maintain a relationship between the original data and the repurposed data. As a more specific example, when creating a contact from ink data originally present in an ink entry application program, information may be stored in the source application program to indicate that “this specific ink data was made into an address book entry” and/or to create a link in the source application program to that specific address book entry. Similarly, the specific address book entry containing the repurposed ink may include stored information to indicate that “this specific address book entry originated from a specific ink document” and/or to create a link back to the ink in the specific source document. In a similar manner, electronic calendar entries, emails, tasks, and the like that include repurposed data may include additional information indicating the originating source of the repurposed data (and/or tying links), and likewise, the document that contained the original data may be modified to include additional information indicating that the original data was repurposed into a specific calendar entry, email, task, etc. and/or tying links to these specific items. The stored additional information may allow user access to other documents or information stored on the system that is related to the repurposed data.

Any manner of providing the additional information in the source and/or target application programs may be used without departing from the invention. For example, an icon or other visible indicator may be present adjacent the original and/or repurposed data to indicate that there is additional information (such as stored history) associated with the data (e.g., clicking or tapping on the icon or visual indicator may be used to call up the additional information and/or directly access the tied information). As another example, the additional information may be stored as “metadata” that is searchable by the user.

The additional information associated with the original and/or repurposed data need not include information that directly links the original and repurposed data to one another. Rather, any suitable information can be stored without departing from the invention. For example, when repurposing ink to create an electronic calendar entry, additional data may be stored to indicate other desirable information, such as: the meeting time, date, attendees, and/or subject matter; the originating document creation date, name, author, or other source information; lists of other linked documents or entries (e.g., notes from that meeting and/or related meetings); etc. Accordingly, the original data and/or the repurposed data can be “tagged” in any suitable manner with any desired additional information, and this information may be used, in at least some examples of the invention, for searching, organizing, retrieving the desired information and related information.

The following includes a more detailed description of various examples of systems, methods, and computer-readable media according to the invention, including a description of examples of various user interfaces that may be used in conjunction with this invention. The reader should understand that this detailed description merely describes examples of various aspects of the invention and does not limit the invention.

III. Example Systems and Methods Relating to Ink Repurposing

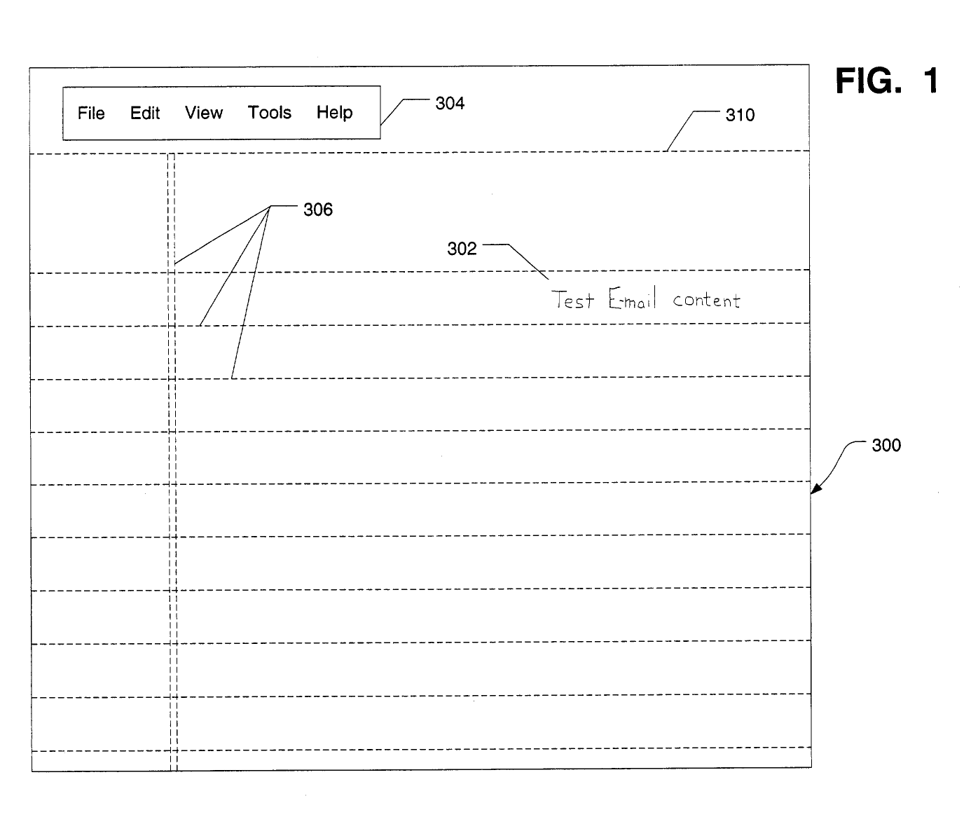

FIG. 1 generally illustrates an example of a user interface display screen 300 that may be generated by an application program in a pen-based computing system that allows a user to enter handwritten text as electronic ink (or otherwise allows the introduction of electronic ink data). Such systems and application programs are available, for instance, for use with tablet PCs, such as the Windows Journal electronic document program. As an example, FIG. 1 illustrates an electronic document 310 that includes the handwritten text 302 “Test E-mail content” in electronic ink as it might appear when written on a digitizing display screen 300 like those used in conjunction with tablet PCs. Of course, the electronic document 310 may contain any other suitable information, including electronic ink in addition to that shown at reference number 302. The additional information included in electronic document 310 may include, for example, machine-generated text, graphics, drawings, handwritten electronic ink text, equations, tables, charts, music, embedded audio and/or video files, icons, or any other suitable or desired information.

While any suitable user interface may be used in the electronic document application program, the illustrated example interface shows a conventional toolbar 304, including drop down menus for the tools “File,” “Edit,” “View,” “Tools,” and “Help,” as are conventional and well known to those skilled in the art. Also, while not required, the electronic document 310 of FIG. 1 includes system-generated lines 306 to simulate the appearance of lined paper. Other conventional electronic document navigation tools, such as page up/down buttons, scroll bars, and the like, also may be provided without departing from the invention.

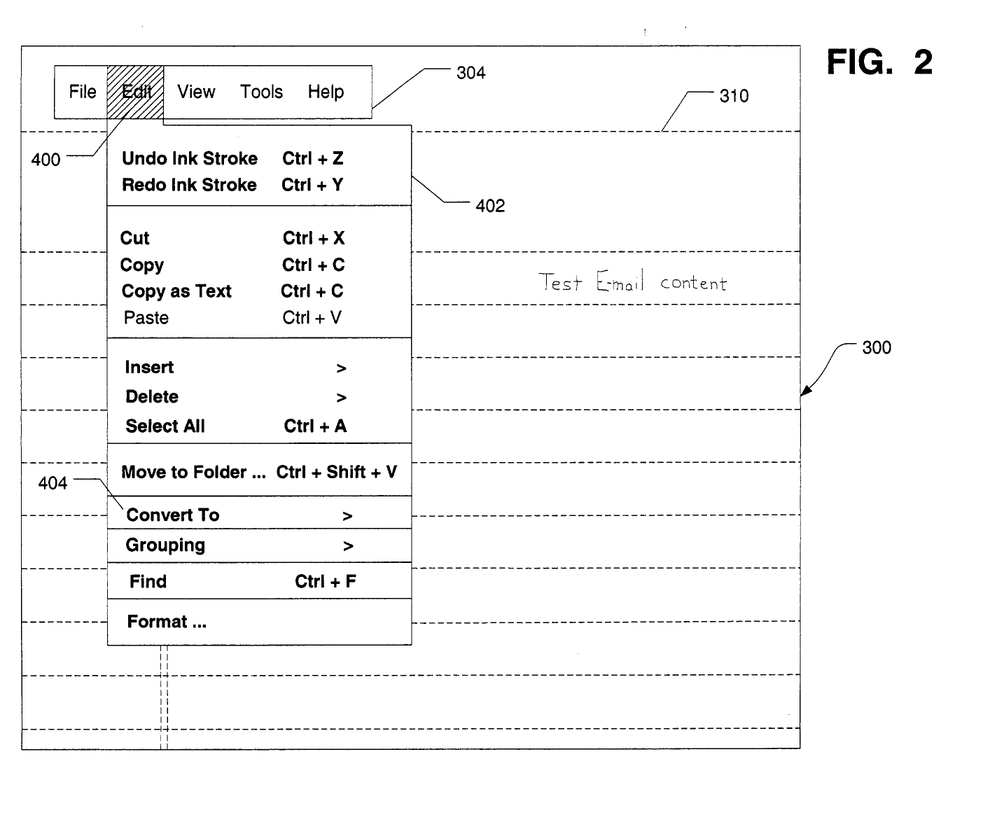

FIG. 2 illustrates additional features of an electronic document application program that may be used in some examples of this invention. In this example, the “Edit” button 400 on toolbar 304 has been activated, as shown by the shading over the Edit button 400. As is conventional, activation of the Edit button 400 results in display of a drop down menu 402 that lists various options that a user may use or activate, such as undo, redo, cut, copy, copy as text (e.g., convert a selection from electronic ink to text and copy it), paste, insert, delete, select all, move to a specified folder, grouping, find, and format. Any suitable options may be including in the listing of the drop down menu 402 without departing from the invention. Additionally, the system may automatically provide a fixed drop down menu 402 and/or a user may be allowed to customize all or a portion of the content of drop down menu 402 without departing from the invention.

One option available through the example drop down menu 402 that is of interest with respect to the present invention involves the “Convert To” button 404 (of course, the options tied to the Convert To button 404 may be activated in other suitable manners and/or the button 404 may be located at other places without departing from the invention). The Convert To button 404, in accordance with this example of the invention, allows the user to designate a target application program to which designated or selected electronic ink will be transferred.

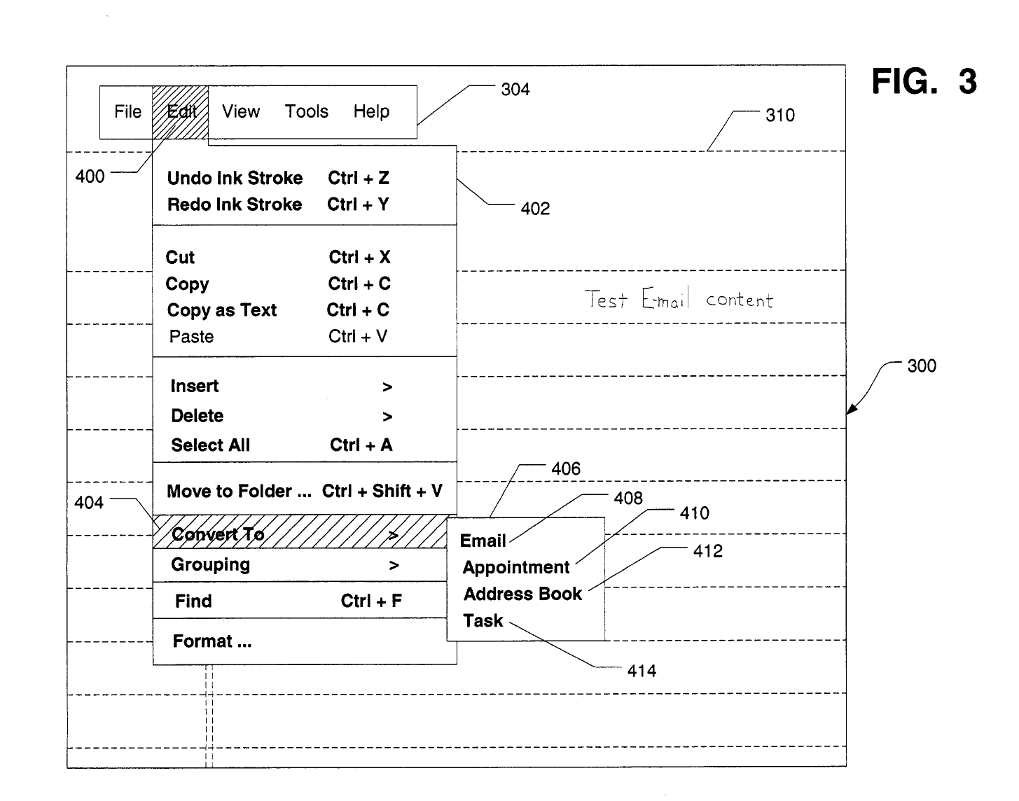

When activated in this example of the invention (e.g., by clicking, tapping, or the like), the Convert To button 404 opens a pulldown menu 406, as illustrated in FIG. 3 (button 404 activation is illustrated in FIG. 3 by shading). This pulldown menu 406 illustrates a number of target application program options available to the user when utilizing the “Convert To” function. While other target application program options also potentially may be available and listed in the pulldown menu 406, the Convert To function in this example of the invention allows the user to select a target application program from menu 406 that includes: an email target application program 408, an electronic appointment book or calendar application program 410, an electronic address book or contact list application program 412, and an electronic task manager application program 414. While merely examples of possible target application programs that can be designated to receive electronic ink data, these various options from menu 406 are discussed in more detail below.

A. Conversion or Transfer to an Email Application Program

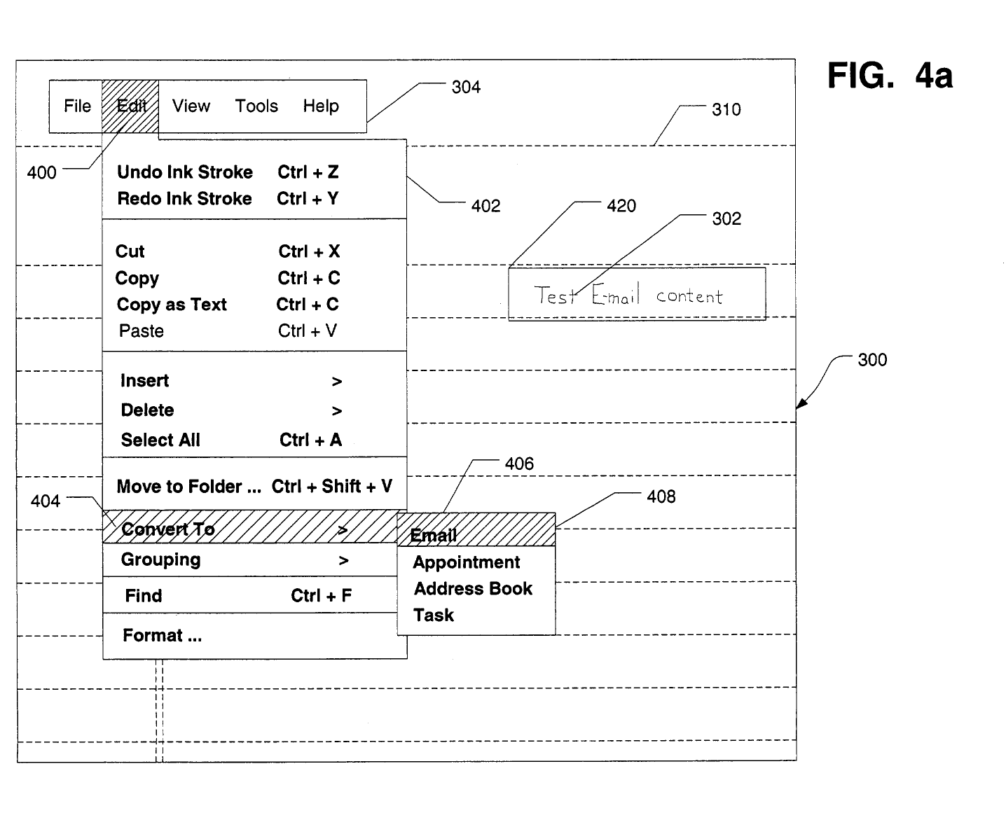

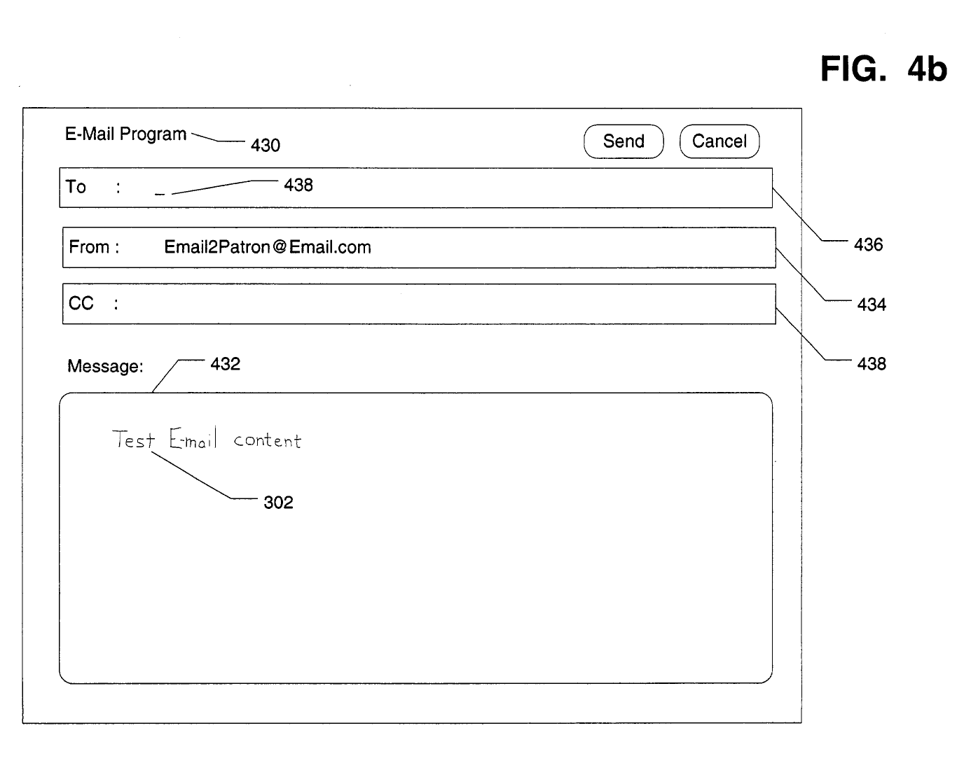

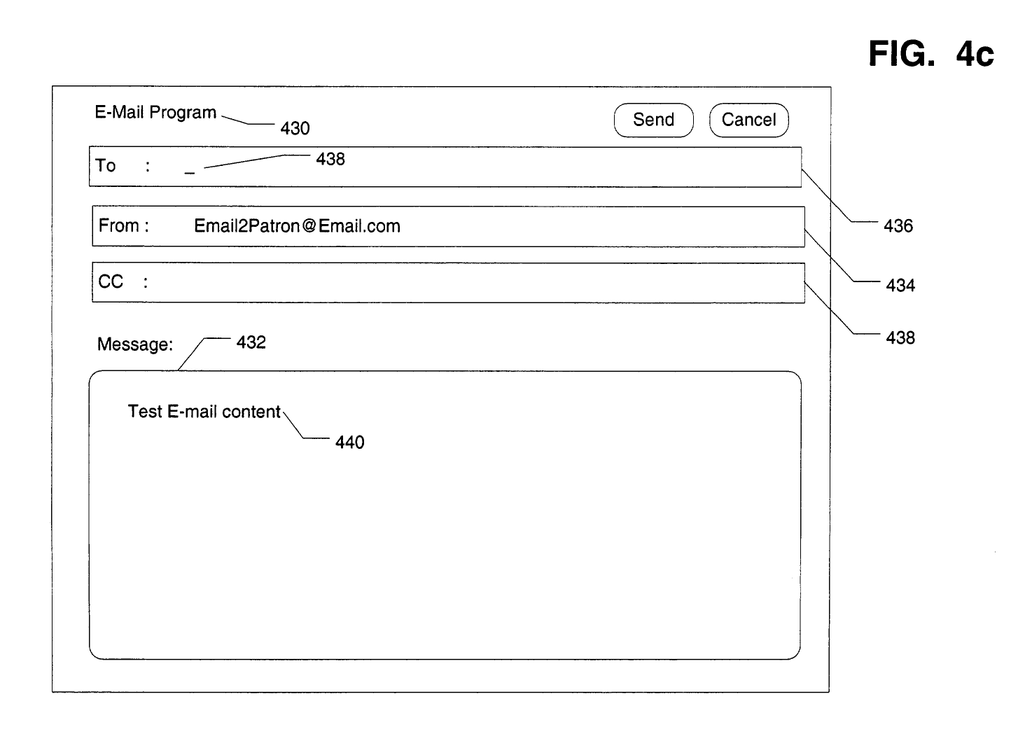

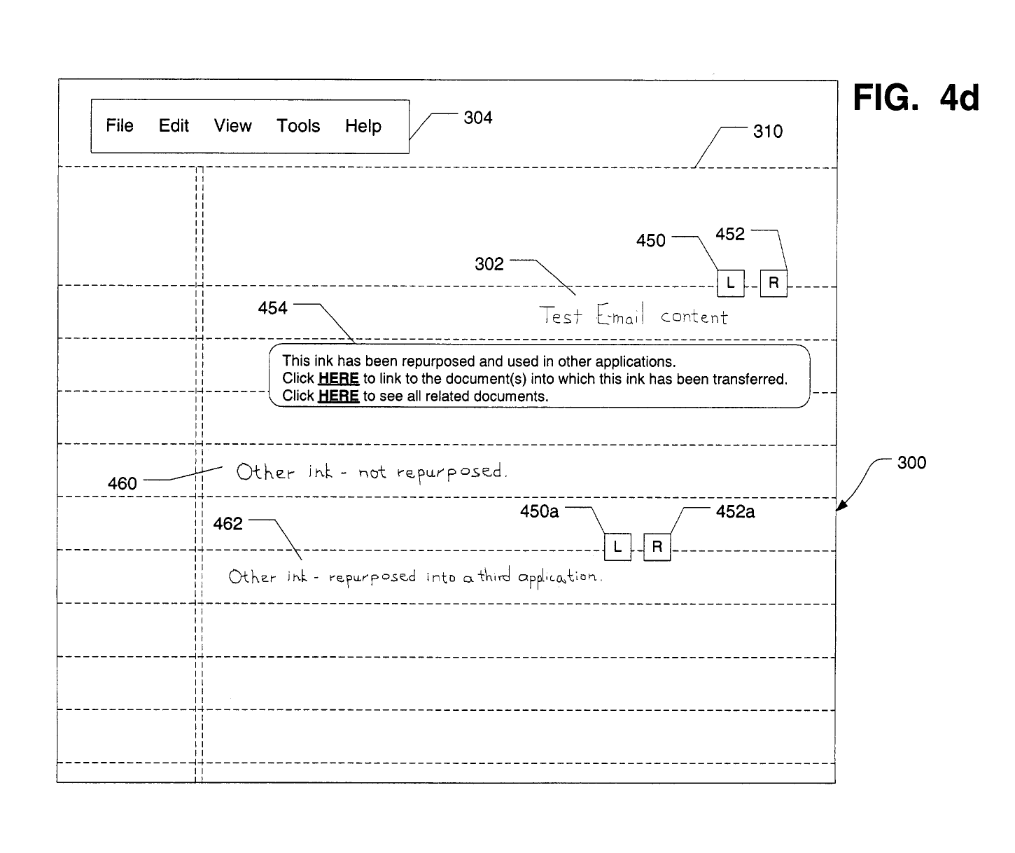

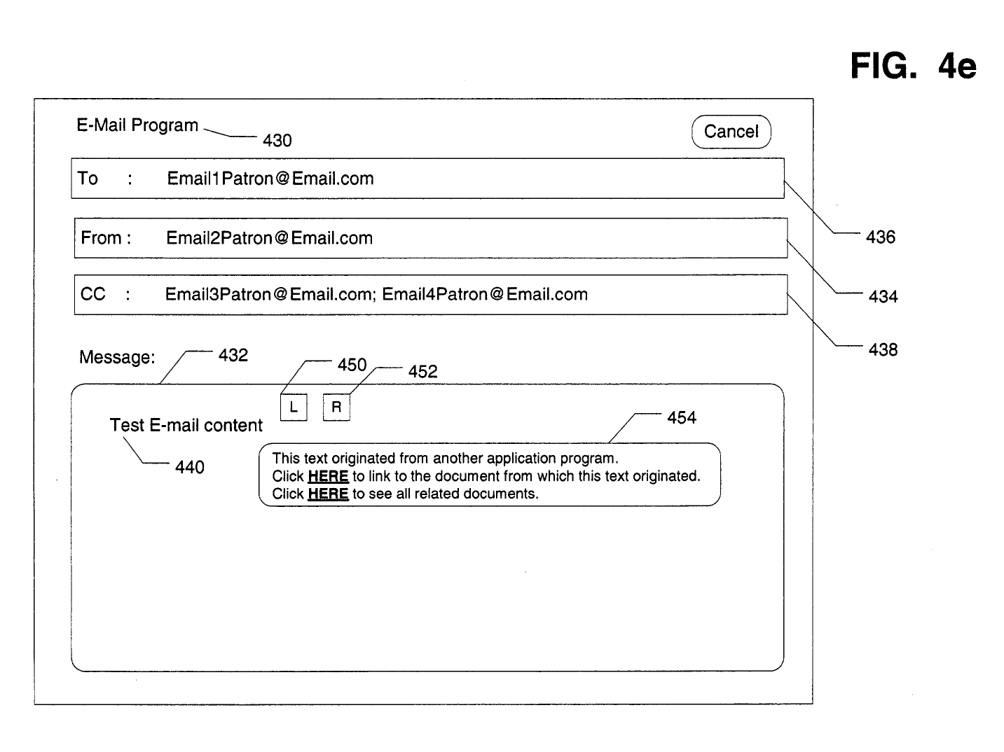

FIGS. 4a through 4e illustrate examples of the results obtained when a selected handwritten electronic ink message is converted and/or transferred to an email application program in accordance with one example of the invention. First, in this example, a user selects the electronic ink text to be converted and/or transferred to the email application program. This may be accomplished in any suitable manner, such as by utilizing a conventional lasso select feature, a click-and-drag action (e.g., using a mouse, stylus, or other appropriate user input device), or in any other suitable manner. In the example of FIG. 4a, the text 302 “Test E-mail content” has been selected, as illustrated by selection box 420. After the selection is made, the Edit button 400 is activated, which exposes drop down menu 402 and displays the Convert To button 404, which also is activated to expose pulldown menu 406. Then, the “Email” button 408 is activated, which indicates to the system that the user desires to convert the selected text 302 to an email in an email application program. The various button activations are illustrated in FIG. 4a by shading.

Once the Email button 408 is activated, the system transfers to (and opens, if necessary) an email application program 430. As illustrated by the example in FIG. 4b, this action can automatically initiate the preparation of a new email message by placing the selected text 302 directly into the email message field 432, placing the logged in user's name in the “From” box 434, and prompting the user to enter one or more email addresses into the “To” box 436. In the illustrated example, the prompt consists of an active cursor 438 in the “To” box 436, but other suitable prompts also may be used, such as opening an email address book or the like.

Of course, without departing from the invention, a user at any time could add and/or attach additional information to the email, including additional electronic ink, machine-generated text, drawings, graphics, music, embedded files, attachments, etc. Additionally, at any time before the email is sent, the user may add additional recipient's names in the To box 436, the CC box 438, and a BCC box (not shown) without departing from the invention. In short, users can perform any desired functions with the email message and application program illustrated in FIG. 4b as they can with conventional email systems and application programs as known in the art. Once the email information is completed, the email can be sent in the conventional manner known in the art.

FIG. 4c illustrates an alternative transfer procedure to an email application program that may be used in some examples according to the invention. The email application program and email user interface in this example are similar to those illustrated in conjunction with FIG. 4b, except in this example system, the handwritten text 302 is converted to machine-generated text 440 prior to its entry into the message field 432. Such conversion can take place using conventional handwriting recognizers, which are known to those skilled in the art.

The handwriting recognition and conversion to machine-generated text can take place at any suitable time, without departing from the invention. Additionally, the handwriting recognizer may be included as part of the electronic ink document application program, as part of the email application program, or as a separate application program that is called by one of the other application programs. As other options, without departing from the invention, either the electronic document application program and/or the email application program may run various applications on the text of the converted and/or email message before finally sending it out, such as a spell check, grammar check, or the like.

While the above description indicates that the selected ink text 302 (or the corresponding machine-generated text 440) is automatically inserted into the message field 432 of the newly opened email message, this is just an example. Generally, the electronic ink text 302 and/or machine-generated text 440 could go to any location in the email interface without departing from the invention. For example, if the data set to be sent to the email application program is run through a classification system and/or a parser before it is entered into the email, the parser and/or classification systems may recognize various features of the selected text and send different portions of the text to different parts of the email message interface. As examples, the parser and/or classification systems may recognize ink strokes and stroke sets that contain various strings commonly found in email addresses, such as: “TO:,” “CC:,” “@, ” “.com,” “.net,” “.gov,” “.edu,” and the like. Systems and methods according to some examples of the invention could be set up to recognize these stroke sets and “smartly” place the stroke sets and any associated strokes into the correct locations in the email interface.

For example, as one rule, systems and methods according to some examples of the invention could look for and recognize ink “words” containing both the symbol “@” and a last stroke set selected from the group consisting of “.com,” “.net,” “.gov,” “.edu,” and the like, optionally taking into consideration the location of such ink words in the selected ink text. When located at the very beginning of the selected ink text, such systems and methods could then recognize these types of ink “words” as email addresses. Once recognized as email addresses, these example systems and methods may automatically place these “words” in the “To” box 436 of the email program interface. As another rule, systems and methods according to some examples of the invention could recognize stroke sets containing “TO:” and/or “CC:” and/or “BCC:” as being followed by a list of desired email recipients and place these e-mail addresses or names automatically in their proper boxes, such as boxes 436 and 438. Optionally, some examples of such systems and methods could use email address books and aliases to insert the correct email addresses for conventional names if stored on the system (e.g., if the system recognizes the string “TO: John Doe,” it could automatically retrieve the associated email address for the stored alias “John Doe” and place the email address or alias in the To box 436). Of course, in examples of the invention where this type of automatic placement is used, the systems and methods also can allow users to freely modify the location of the automatically inserted information, to correct any errors made by the systems and methods.

FIGS. 4d and 4e illustrate examples of the source document and the email message document after ink repurposing has taken place in some systems and methods according to the invention. In these examples, additional information is stored and associated with both the original ink and the repurposed ink.

FIG. 4d illustrates the original or source ink document 310 from which ink was taken and repurposed into an email message. In this source document 310, the actual ink text 302 that was repurposed is marked with icons 450 and 452. The repurposed ink also may be visually marked in other ways, for example, by rendering it in a different color, underlining, bolding, italicizing, highlighting, and the like. The source document 310 may contain other ink that was not repurposed (e.g., ink 460). Additionally, if the source document 310 contains other ink that also was repurposed (e.g., ink 462), that ink 462 also may be marked with icons 450(a) and 452(a) (and/or other suitable indicators).

In this illustrated example, the icon 450 labeled “L” allows the user to directly link to the email message that contained the repurposed ink. Therefore, for example, clicking or tapping on L icon 450 will directly transfer the user to the stored email message document into which this ink was transferred (illustrated, for example, in FIG. 4e). This email message may be stored, for example, in the email application program, such as in the user's “OUTBOX” or “SENT” box, in a document management system, or in any other suitable manner on the system. The email application program or document management system may be opened, if necessary, when the L icon 450 is pressed. If the ink text 302 was repurposed into more than one application, a list of documents containing the repurposed ink may be provided, all of the documents could be brought up automatically on the system, and/or the user could be advised of this fact in any other suitable manner.

The icon 452 labeled “R,” in this example, allows the user access to all stored documents that, in some manner, relate to the repurposed ink. For example, by clicking on or tapping R icon 452, the user may be provided with a list of links to documents that relate to the repurposed ink. Related documents may include, for example: all emails stored on the system in the chain that included the repurposed ink (e.g., the original email, all replies, all forwards, all parent emails); all other documents into which the repurposed ink was pasted; and the like.

Another example of a visual indicator that may be used in combination with or in place of the icons 450 and/or 452 is illustrated in FIG. 4 as text box 454. This text box 454 merely provides another manner in which the user can directly link to the repurposed ink information and/or other related documents. The text box 454 may be located at any suitable location on the interface screen or appear in any suitable manner without departing from the invention. In some examples, the text box 454 may appear temporarily, as an overlay, at or near the original and/or repurposed ink.

FIG. 4e illustrates an example of a stored email that includes repurposed ink as it might appear in some examples of the invention. In this example, the repurposed ink (in machine-generated text form 440) includes the L icon 450 and the R icon 452 associated with it. The L icon 450, when activated, links the user back to the document from which the repurposed ink originated. The R icon 452, as described above, provides a list of links to all documents that relate in some manner to this repurposed ink. As another or alternative example, FIG. 4e illustrates a text box 454, which operates in the same manner as described above with respect to FIG. 4d.

The icons (or other indicator(s) of additional stored information) in both the source application program and the target application program may appear at any suitable time or in any suitable manner without departing from the invention. For example, the icons, text box, or other indicators may be visible at all times, as soon as the ink is repurposed. As another example, the icons, text box, or other indicators may appear as a result of a hover action at or near the original and/or repurposed ink (e.g., a “hover action” may be accomplished, for example, by holding a pen or stylus slightly above a digitizing display surface screen over the original and/or repurposed ink, by moving a pointing device associated with a mouse (or other user input device) over or near the original and/or repurposed ink, and the like). As still another example, a toolbar menu item could be provided (e.g., in toolbar 304) that allows the user to locate original ink that was repurposed and/or entries that resulted from repurposed ink.

The links and/or related document information may be maintained dynamically, such that information can be added and deleted, as the user adds and/or deletes relevant information from the computer system. Additionally, if the user deletes the documents containing the original ink, the repurposed ink, and/or other related documents, the relevant icons or visual indicators also may be deleted. As another alternative, the user could receive an error message when he/she attempts to link to a document that no longer exists. Any other suitable or desired way of handling this situation may be used without departing from the invention.

B. Conversion or Transfer to an Electronic Calendar Application Program

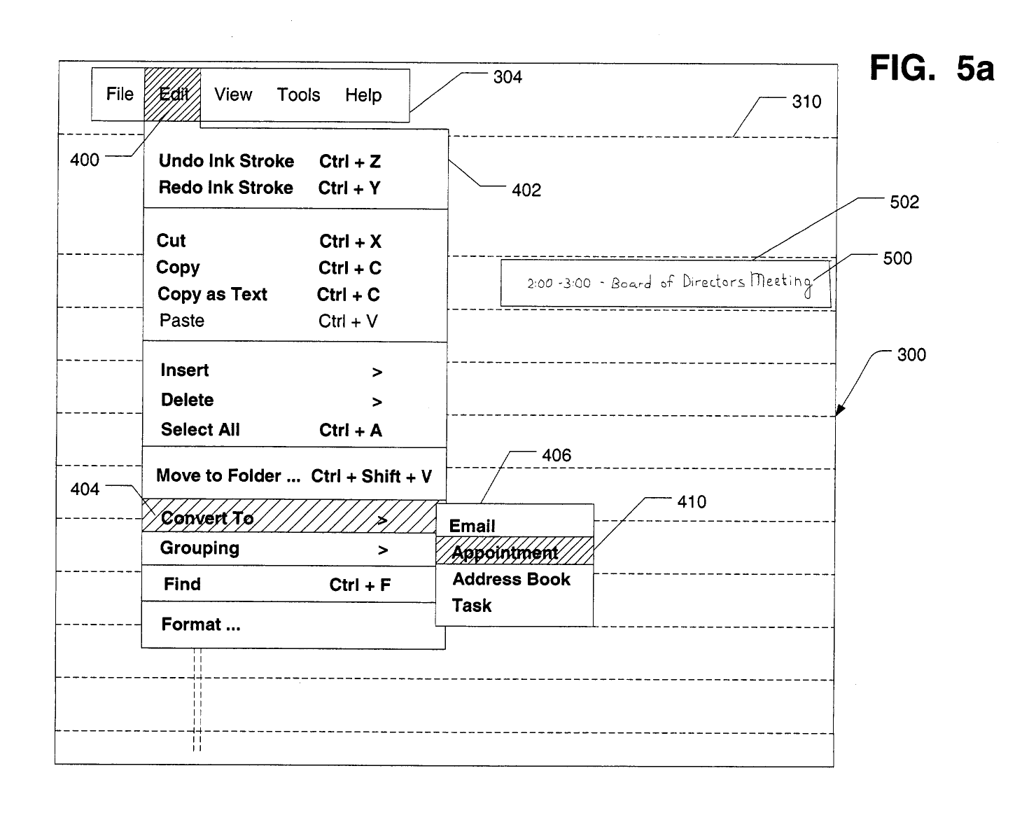

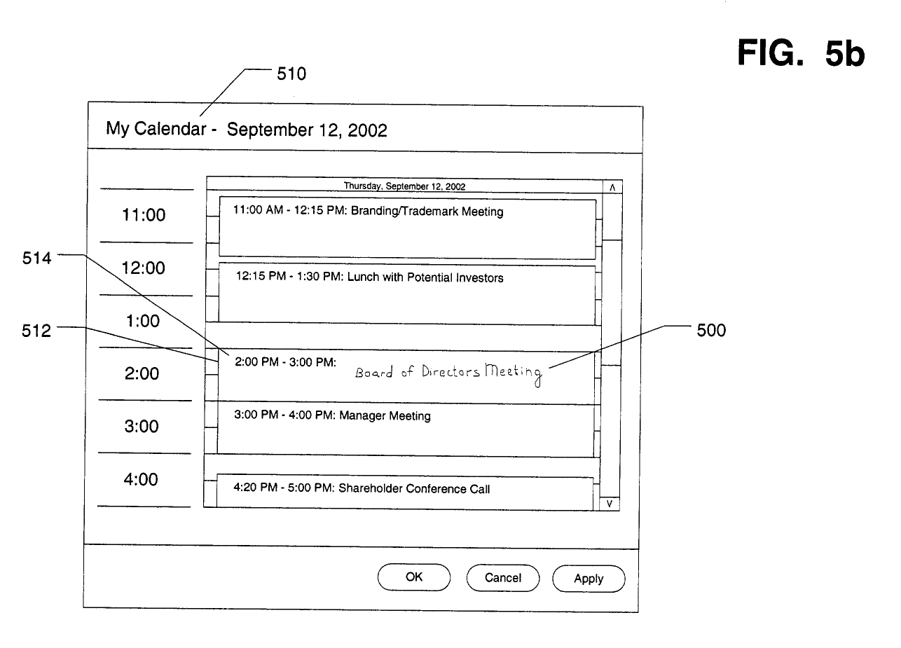

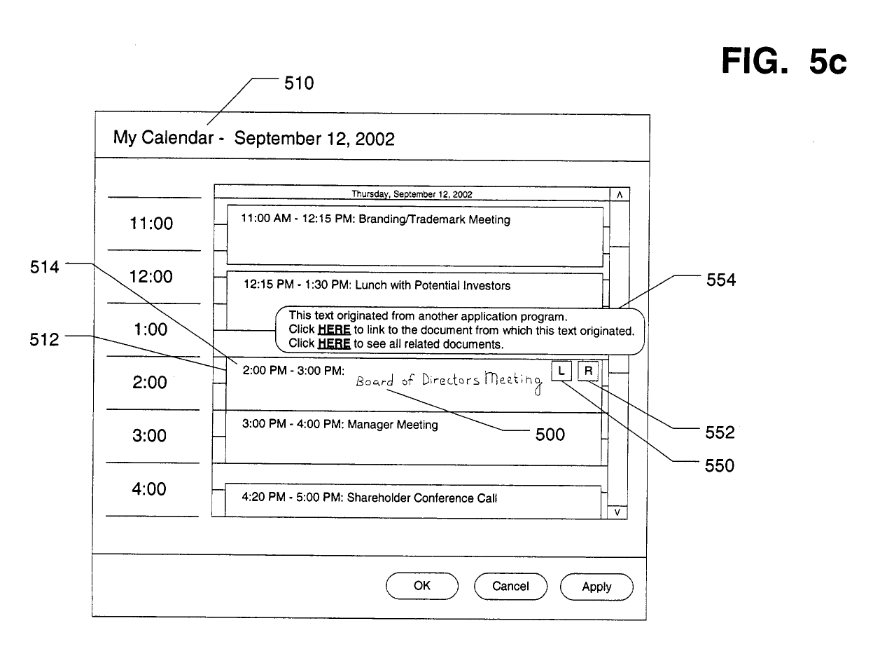

FIGS. 5a-5c illustrate an example of the results obtained when a selected handwritten message is converted and/or transferred to an application program for an electronic calendar (or appointment book or schedule). First, in this example, a user selects the electronic ink text to be converted and/or transferred to an electronic calendar application program. As described above, this may be accomplished in any suitable manner, such as by utilizing a lasso select feature, a click-and-drag action (e.g., using a mouse, stylus, or other appropriate user input device), or in any other suitable manner. In the example of FIG. 5a, the handwritten text 500 “2:00-3:00—Board of Directors Meeting” has been selected, as illustrated by selection box 502. After the selection is made, the Edit button 400 is activated, which exposes, drop down menu 402 and displays the Convert To button 404, which also is activated to expose pulldown menu 406. Then, the “Appointment” button 410 is activated, which indicates to the system that the user desires to convert the selected text 500 to an appointment or entry in an electronic calendar application program. The various button activations are illustrated in FIG. 5a by shading.

Once the Appointment button 410 is activated, the system transfers to (and opens, if necessary) an electronic calendar application program 510, entitled “My Calendar” in the illustrated example (see FIG. 5b). If desired, the systems and methods according to this example of the invention can prompt the user to enter any necessary information, such as the meeting time and/or the meeting date prior to entering the text 500 into the calendar. Prompts for entry of the meeting date and/or time may be the first items viewed by the user when transferring or converting the electronic ink text to an entry in the electronic calendar program 510, although any appropriate method for entering this information into the systems and methods of the invention could be used without departing from the invention.

In the illustrated example, the selected text 500 included the meeting time, but not the meeting date. In this instance, systems and methods according to some examples of the invention could recognize the start and/or end times in the handwritten text 500 (e.g., by recognizing the “Number-Colon-Number-Number” pattern or “Number-Number-Colon-Number-Number” pattern commonly used when writing times), prompt the user to enter the meeting date, and automatically enter the text of the meeting name into the electronic calendar for the selected date at the noted time. Such a system is illustrated in FIG. 5b. Notably, in FIG. 5b, the handwritten text 500 entered into the electronic calendar 510 contains only the meeting name in the correct time slot 512 for the meeting (i.e., the 2:00 to 3:00 time slot in this example). In this example, the text of the time 514 is machine-generated, like the remaining time text on the electronic calendar page. Of course, prior to entering it into the electronic calendar 510, all of the handwritten text 500 could be converted to machine-generated text, or all of the text, including the text corresponding to the time 514, could be left as handwritten text, without departing from the invention.

As another alternative or additional feature, in some instances the selected handwritten text 500 also may include a date. This fact may be recognized by systems and methods according to some examples of the invention (e.g., from a conventional MM/DD/YEAR pattern, a MM-DD-YEAR pattern, a Month Name-Number-(Optional Number)-Comma-Number-Number-Number-Number pattern, or the like). If so recognized, systems and methods according to at least some examples of the invention may automatically select a date for the meeting along with the time (if it is included in the selection), and attempt to place the meeting name information at the proper time and date locations in the electronic calendar. As described above with respect to FIGS. 4a-4e, however, systems and methods according to these examples of the invention also may include procedures that allow the user to correct and/or approve the automatically selected time, date, or other recognized text information. Also, because typical workdays span from 7:00 am to 7:00 pm, systems and methods according to some examples of the invention also can provide a best guess as to whether the user intends AM or PM when setting up an appointment entry, if no AM or PM is present. Of course, the user also will be capable of changing these automatic selections, if necessary, without departing from the invention.

FIG. 5c illustrates an example of an electronic calendar entry with repurposed ink when additional information is associated with the repurposed ink. The L icon 550 links back to the source document containing the original ink text, and the R icon 552 provides access to all related documents stored on the system, in the general manner described above with respect to FIGS. 4d and 4e. Similarly, the text box 554 provides access to the linked and related documents in the same manner as described above in conjunction with FIGS. 4d and 4e. Of course, the original source document from which the repurposed ink 500 was obtained also could include additional information associated with it, in the same manner as described with respect to FIGS. 4d and 4e.

C. Conversion or Transfer to an Electronic Address Book Application Program

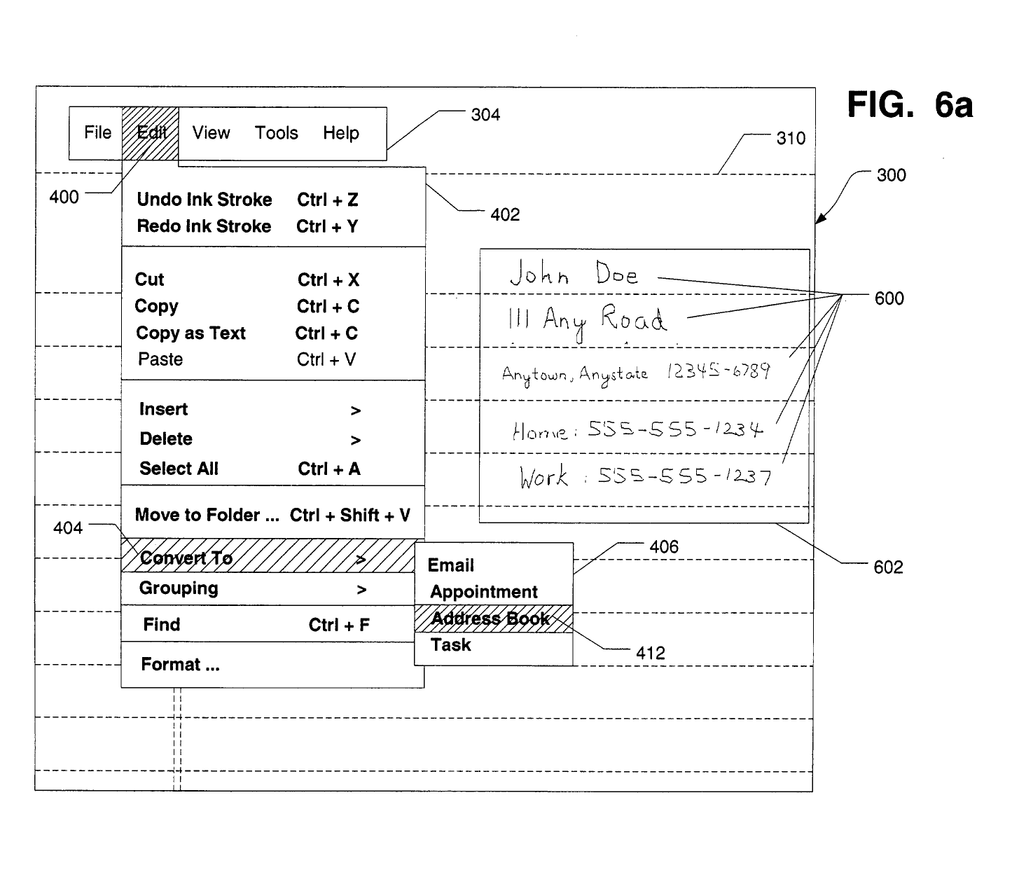

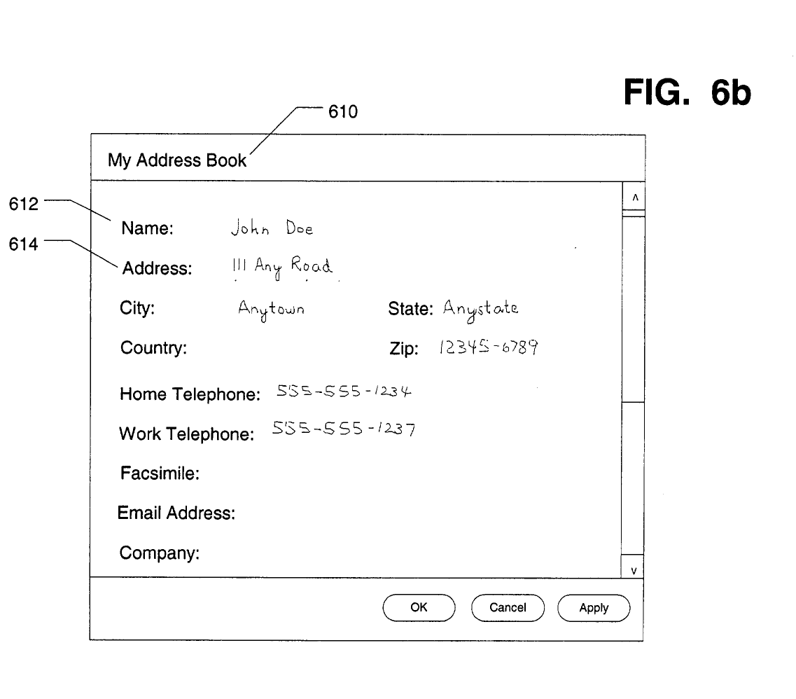

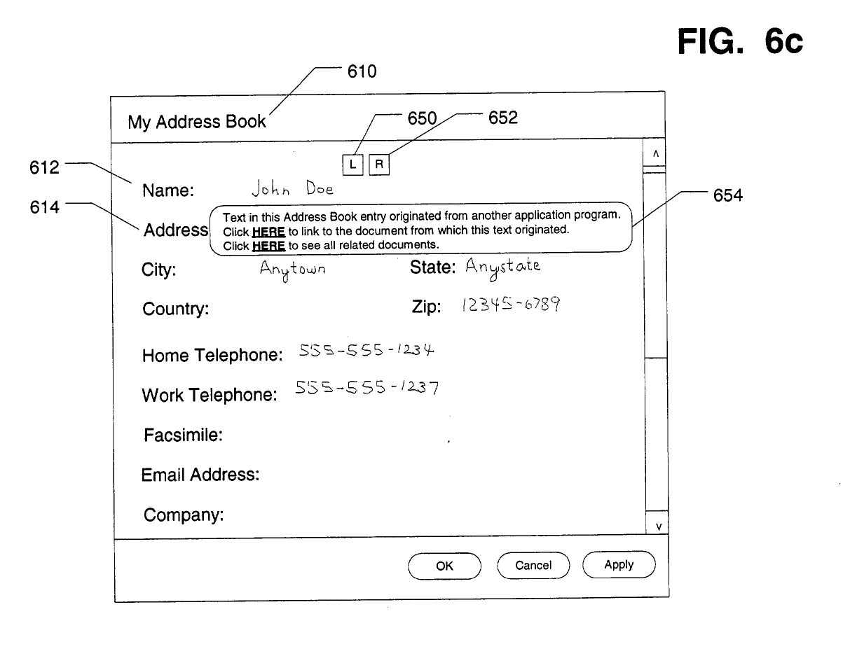

FIGS. 6a-6c illustrate an example of the results obtained when a selected handwritten message is converted and/or transferred to an application program for an electronic address book (also called a “Contact” list or the like). First, in this example, a user selects the electronic ink text to be converted and/or transferred to an electronic address book application program. As described above, this may be accomplished in any suitable manner, such as by utilizing a lasso select feature, a click-and-drag action (e.g., using a mouse, stylus, or other appropriate user input device), or in any other suitable manner. In the example of FIG. 6a, the selected handwritten text 600 includes complete address and telephone information for “John Doe,” as illustrated by selection box 602. After the selection is made, the Edit button 400 is activated, which exposes drop down menu 402 and displays the Convert To button 404, which also is activated to expose pulldown menu 406. Then, the “Address Book” button 412 is activated, which indicates to the system that the user desires to convert the selected text 600 to an entry in an electronic address book or contact application program. The various button activations are illustrated in FIG. 6a by shading.

Once the Address Book button 412 is activated, the system transfers to (and opens, if necessary) the electronic address book application program 610, entitled “My Address Book” in the illustrated example (See FIG. 6b). Again, using parsing and/or classification analysis, systems and methods according to at least some examples of the invention may make best guesses as to where various information in the selected handwritten electronic ink text 600 should be placed in the address book page. As an initial matter, user input (e.g., activating the Address Book button 412) has already informed the system that the selected text corresponds to an address or some type of contact information. Accordingly, systems and methods according to some examples of the invention may make a judgment that the first line of text corresponds to the contact's name, and place this line in the name field 612 of the address book page. Since name (either business or personal) typically is the only information contained on the first line of an address or contact information, this entire line can be placed in the name field 612, at least in some examples of the invention.

As for the second and following lines of selected text 600, these may correspond to a variety of different contact information, such as home address, business address, email address, telephone numbers, facsimile numbers, company name, etc. Nonetheless, systems and methods according to at least some examples of the invention can make their best guess as to where the pieces of information on a line should go. For example, U.S. street addresses typically include a short series of numbers and/or letters followed by a word like “Road,” “Street,” “Avenue,” “Boulevard,” “Lane,” “Court,” “Way,” “Apartment,” etc., or their common abbreviations. If a line of text contains these patterns, systems and methods according to some examples of the invention could consider these lines as containing street addresses, and place this information in address field 614. Similarly, systems and methods according to some examples of the invention can recognize the common stroke patterns associated with the city and state portion of an address, for example, by the common Word-Comma-Word pattern, optionally also taking into account the various U.S. state names and their common abbreviations, and also optionally taking into account their conventional location after text recognized as an address field. Zip codes, telephone numbers, email addresses, and other contact information also may be recognized by systems and methods according to some examples of the invention by their common patterns. When so recognized, these words and numbers also can be placed in their appropriate fields on the address book page, in the same manner as described above.

As with the other examples described above, in systems and methods according to examples of the invention in which information is automatically placed in various fields, a user can be given the opportunity to change or correct errors in the automatic placement. Also, of course, users can be given the opportunity to correct any errors in character recognition for systems in which machine-generated text is inserted into the electronic address book. It is anticipated that systems and methods according to at least some examples of the invention will be freely modifiable and editable by the users to correct any errors, provide address updates, replace handwritten text with machine-generated text, and make other changes, like various options that exist in currently available electronic address book application programs.

As another alternative, the electronic address book application programs used in systems and methods according to some examples of the invention may not include various fields, like those illustrated in FIG. 6b. In such instances, the selected handwritten text 600 could be placed in the electronic address book as a single data entry, either with or without converting it to machine-generated text, without departing from the invention. As another alternative, the selected handwritten text 600 could be placed in the address book in a single field (as either handwritten or machine-generated text), but the user could, if they desire, move the various portions of the text to other fields also provided in the address book (e.g., fields for street address, city, state, zip code, telephone numbers, email address, business information, etc.). As still another alternative, systems and methods according to some examples of the invention could prompt the user to select various fields for words and/or lines of text as the information is being moved into the electronic address book page.

Additionally, the various fields illustrated in FIG. 6b are merely examples of possible fields that may be included in an address book entry according to the invention. Any desired information can be included in an electronic address book entry and/or field in the address book without departing from the invention. Additionally, the electronic address book can be designed to allow its fields to be readily modified by the user.

FIG. 6c illustrates an example of an electronic address book or contact entry with repurposed ink when additional information is associated with the repurposed ink. The L icon 650 links back to the source document containing the original ink text, and the R icon 652 provides access to all related documents stored on the system, in the general manner described above with respect to FIGS. 4d and 4e. If desired, each individual field in the address book page could include separate icons 650 and 652. Also, the text box 654 provides access to the linked and related documents in the same manner as described above in conjunction with FIGS. 4d and 4e. Of course, the original source document from which the repurposed ink 600 was obtained also could include additional information associated with it, in the same manner as described with respect to FIGS. 4d and 4e.

D. Conversion or Transfer to an Electronic Task Management Application Program

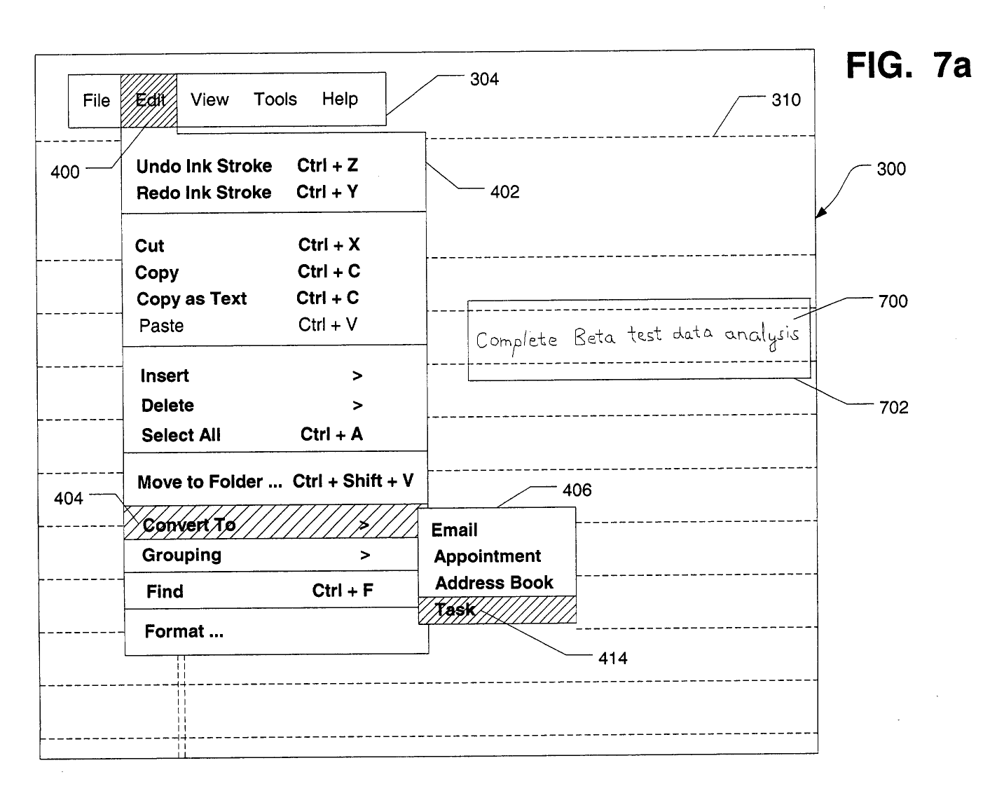

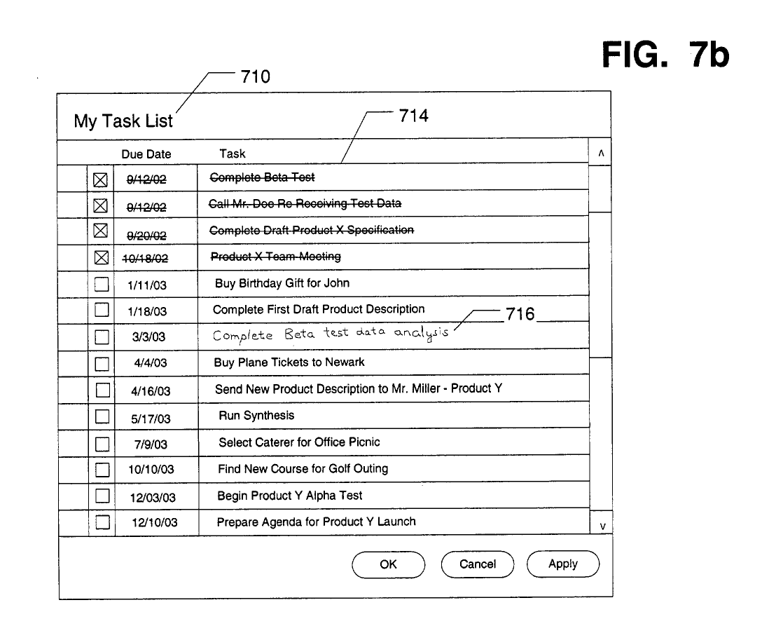

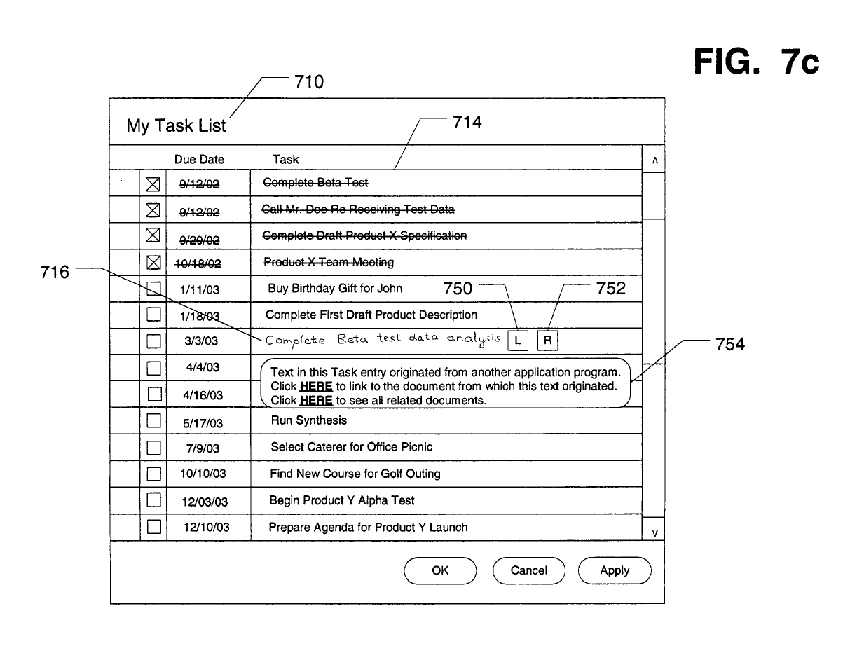

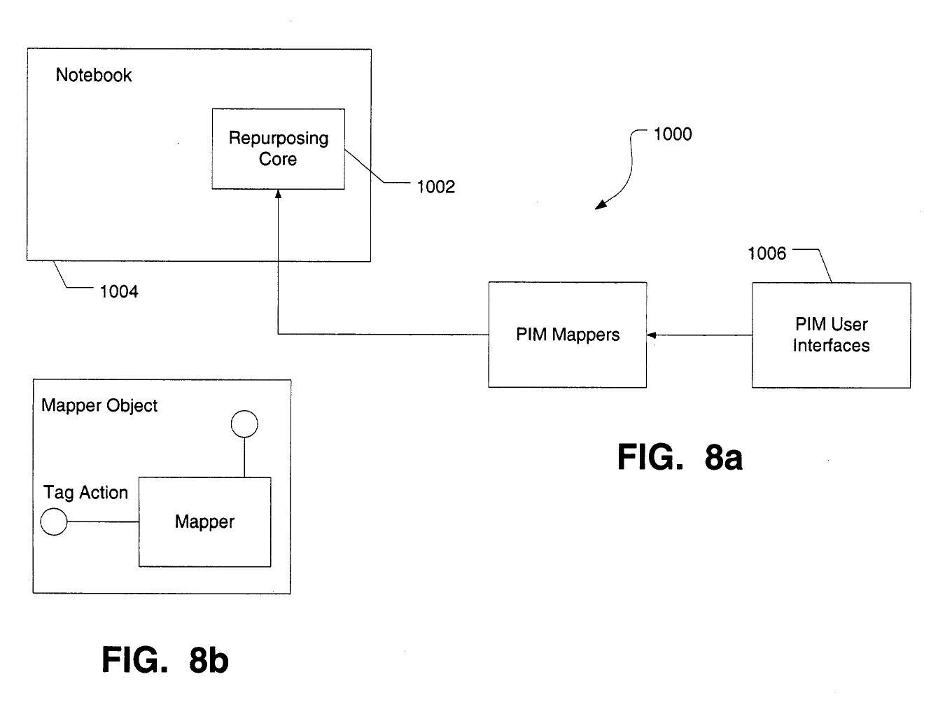

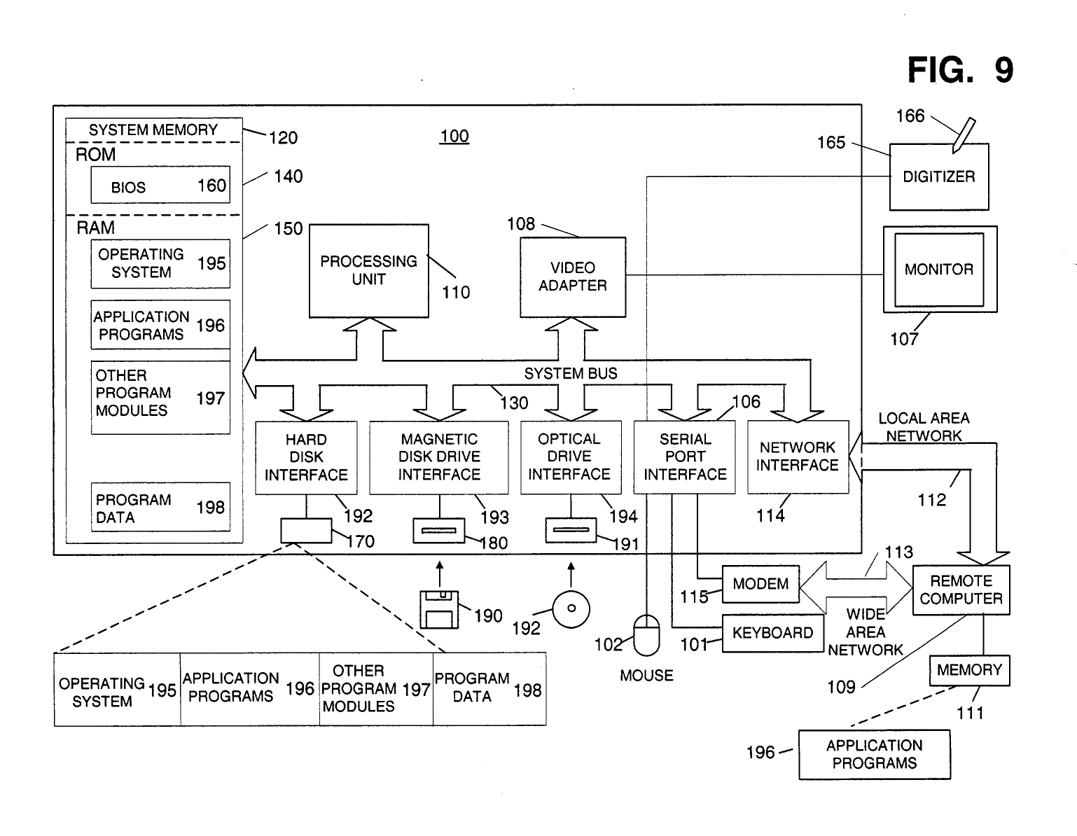

FIGS. 7a-7c illustrate an example of the results obtained when selected handwritten text is converted and/or transferred to an application program for an electronic task manager. First, in this example, a user selects the text to be converted and/or transferred to an electronic task manager application program. As described above, this may be accomplished in any suitable manner, such as by utilizing a lasso select feature, a click-and-drag action (e.g., using a mouse, stylus, or other appropriate user input device), or in any other suitable manner. In the example of FIG. 7a, the handwritten text 700 “Complete Beta test data analysis” has been selected, as illustrated by selection box 702. After the selection is made, the Edit button 400 is activated, which exposes drop down menu 402 and displays the Convert To button 404, which also is activated to expose pulldown menu 406. Then, the “Task” button 414 is activated, which indicates to the system that the user desires to convert the selected text 700 to a task in an electronic task management application program. The various button activations are illustrated in FIG. 7a by shading.

Once the Task button 414 is activated, the system transfers to (and opens, if necessary) the electronic task management application program 710, entitled “My Task List” in the illustrated example of FIG. 7b. If desired, systems and methods according to this example of the invention can prompt the user to enter suitable information, such as the task due date (if none is provided in the selected text 700), a desired reminder time and/or manner, and the like, as the text 700 is entered into the task list 714. Prompts for adding the task due date, reminders, and the like (if necessary and/or desired) may be the first items viewed by the user when transferring to the electronic task management program 710, although any appropriate method and/or timing for entering this additional information into the system could be used without departing from the invention.

In the illustrated example, the selected text 700 did not include a task due date. If a date were included, however, this fact could be recognized by systems and methods according to at least some examples of the invention, e.g., from the conventional MM/DD/YEAR pattern, the MM-DD-YEAR pattern, by the Month Name-Number-(Optional Number)-Comma-Number-Number-Number-Number pattern, or the like. If so recognized, systems and methods according to at least some examples of the invention may automatically select a date for the task due date and attempt to place the task information at the proper location in the task list 714. As described with respect to the other examples above, however, systems and methods according to examples of the invention that include automatic input of information also may include procedures that allow the user to correct the automatically selected date or other recognized text information.

Also, while the illustrated example of FIG. 7b includes the newly added task 716 as handwritten electronic ink text 700, it also or alternatively may be converted to machine-generated text, either before or after its initial entry into the task list 714, without departing from the invention.

FIG. 7c illustrates an example of an electronic task manager entry with repurposed ink when additional information is associated with the repurposed ink. The L icon 750 links back to the source document containing the original ink text, and the R icon 752 provides access to all related documents stored on the system, in the general manner described above with respect to FIGS. 4d and 4e. Similarly, the text box 754 provides access to the linked and related documents in the same manner as described above in conjunction with FIGS. 4d and 4e. Of course, the original source document from which the repurposed ink 700 was obtained also could include additional information associated with it, in the same manner as described with respect to FIGS. 4d and 4e.

E. Other Information Associated with Original Ink and/or Repurposed Ink

As described above, additional information may be associated with original source ink that has been repurposed and/or with the repurposed ink. While direct links between the original and repurposed ink and/or links to other related documents including the original and/or repurposed ink are described above, the “additional information” that may be associated with the original ink and/or repurposed ink is in no manner limited to these types of linking information.

For example, the “additional information” may include identifying information that relates to the source document, the target document, or documents relating to the source document and/or the target document. As examples, identifying information associated with an email might include data relating to: mail recipient IDs (optionally divided into “TO:,” “CC:,” and “BCC:” categories); mail date; mail time; mail sender; attachment names; links to attachments; priority status; subject line; document from which the ink originated; document containing the repurposed ink; related documents; and the like. Example identifying information associated with an electronic calendar entry may include data relating to: calendar entry creation time and/or date; meeting time (actual and/or scheduled); meeting date (actual and/or scheduled); meeting location (actual and/or scheduled); meeting attendees; meeting invitees; subject matter; meeting organizer; keynote speaker; agenda; schedule; document from which the ink originated; document containing the repurposed ink; related documents; and the like. Example identifying information that may be associated with an electronic address book entry includes data relating to: address book entry creation date and/or time; information from the various address book fields for the entry; document from which the ink originated; document containing the repurposed ink; related documents; and the like. Example metadata that may be associated with a task list entry may include data relating to: task list entry creation date and/or time; subject matter; identification of others working on the task; supervisor; task assignor; task due date; reminder date(s); document from which the ink originated; document containing the repurposed ink; related documents; and the like.

There also is no requirement that the additional information be visible to users. Rather, the additional information may be located in metadata associated with the original and/or repurposed ink and/or their associated documents. The metadata may be user searchable. Metadata can provide a useful way of tying various items together, including the original ink and its repurposed version(s), as well as related documents. For example, notes, calendar entries, emails, and other documents relating to all meetings of a given series can be tied together using metadata (e.g., all board meetings, all meetings relating to a specific product, all union meetings, and the like), and then a user can quickly and easily search for, locate, and access this information on the computer system.

F. Interaction Between the Source and Target Application Programs

In some examples of the invention, a computer operating system or application program, such as Windows® Journal, may provide a pluggable architecture for creating and adding to a list or menu of available repurposing actions (if desired, a maximum number of repurposing target items (e.g., 20) may be set to ensure that a repurposing menu does not grow too large). In this example, a provider of an application program suitable as a repurposing target may create a COM object that supports a repurposing interface (e.g., the IJournalAction interface) and to register the program with the operating system (e.g., with the Windows® operating system (available from Microsoft Corporation) and in the Windows® Journal Registry location). The registry location (e.g., the Windows® Journal Registry location) informs the ink entry application program (e.g., Windows® Journal) of the repurposing application programs available. Additionally, this type of registering enables the ink entry application program to create the COM object when it is needed, e.g., using CoCreateInstance( ) Windows® API.

In some examples of the invention, as noted above, when any of the repurposing actions or targets is chosen, the selected ink text data first may be passed through a handwriting recognizer, where it is converted to machine-generated text. The user then may be given an opportunity to make corrections to the recognized text, for example, using a correction interface like that available in Windows® Journal. After the user completes any desired corrections and continues, the repurposing action is executed.

The implementation of repurposing a selection, for example as “email,” uses a messaging application programming interface (“MAPI”) to create an email message with the body containing the recognized text (as described above in connection with FIG. 4c). If desired, a copy of the selected ink may be attached to the email or other target document as an enhanced metafile (emf), it may be attached as a graphical file (e.g., .BMP, .GIF, .PDF, and the like), optionally with the ink in the correct field or fields, it may be attached as a link back to the original document, or it may be available in any suitable manner. Such attachment (or other manner of providing access to the original ink) may occur automatically, if desired, or upon a user's command (e.g., individually, on a per e-mail or other target document basis, and/or as a default setting).

When a repurposing menu is about to be shown, the ink entry application program (e.g., Windows® Journal) may find and create a listing of all the providers registered with it and use its interface (e.g., the IJournalAction interface) to get the menu text and action ID for all the repurposing actions the components provide to add to the menu. If a user then selects any of the target application programs (optionally after going through the correction user interface as described above), the interface (e.g., the IJournalAction interface) executes the action selected. What this action does is entirely determined by the pluggable component (e.g., add the incoming data to a database, create a personal information manager (“PIM”) item, etc.), but the data passed to the provider may be the same for all actions (e.g., for all actions provided by a Windows® Journal IJournalProps interface).

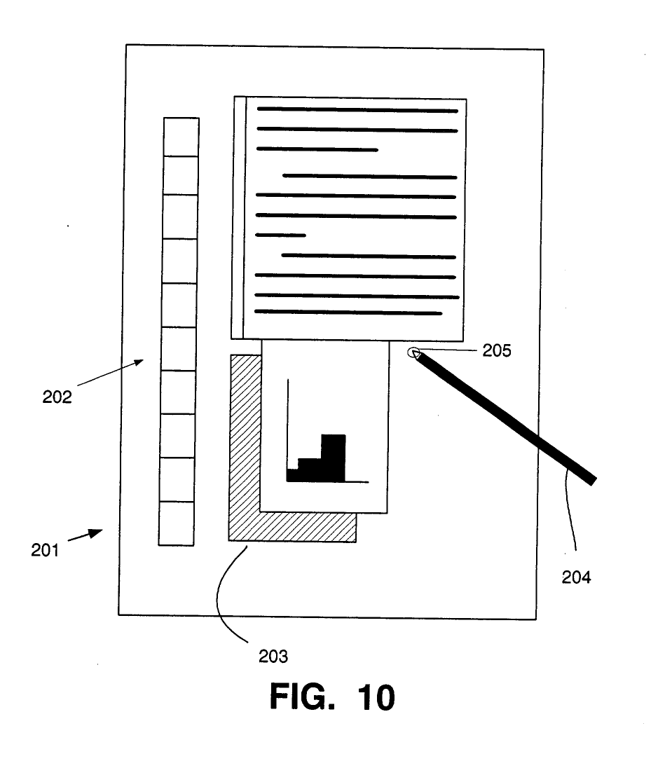

Referring to the example system 1000 illustrated in FIG. 10, the repurposing core 1002 is a class in Notebook 1004 that handles the repurposing selection menu options and calls the appropriate function to carry out the user's request. The functionality of this repurposing core 1002, in this example, includes the following operations:

(A) Repurposing items do not appear in the user interface by default. The repurposing core 1002 will add them to the interface if there is a registered PIM provider upon Notebook 1004 startup.

(B) The repurposing core 1002 will contain the functions called when any of the repurposing user interfaces 1006 is invoked. The repurposing user interfaces 1006, in turn, will call the appropriate PIM provider functions.

(C) The repurposing core 1002 will create/free the PIM provider as needed (i.e., open and utilize the PIM provider application program when a repurposing action is requested, and free it when Notebook 1004 is closed or other predetermined action occurs).

(D) The repurposing core 1002 is responsible for obtaining the original representation of the ink as well as the recognized text for that selection and passing this information on to the PIM provider and/or, if necessary, the type of PIM item desired (e.g., if a PIM provider provides more than one potential target application program).

The PIM provider is an installable component (COM in-proc server) that exposes a provider interface 1006 for a particular PIM (e.g., Outlook, R5, GroupWise, etc.). This provider will “register” itself with Notebook 1004 as the PIM provider by setting a registry key that Notebook 1004 will look at when it starts up. If desired, multiple PIM providers may be registered. The key will provide sufficient information to tell the Notebook 1004 (and specifically the repurposing core 1002), how to create the COM object.

The provider interface 1006, in this example, contains at least one method, namely, CreateItem (type, selected ink, recognized text). During the CreateItem call, the repurposing core 1002 will create a PIM object of the requested type in a default folder. It will then attach the selected ink as an attachment (or otherwise maintain it) and will insert the recognized text at the appropriate location in the target application program. The repurposing core 1002 will then show the created item (e.g., in a user interface form in the target application program) and block further processes until the user dismisses the form. If desired, the user can further add information to the form.

IV. Example Hardware

FIG. 9 illustrates a schematic diagram of a conventional general-purpose digital computing environment that can be used to implement various aspects of the present invention. In FIG. 9, a computer 100 includes a processing unit 110, a system memory 120, and a system bus 130 that couples various system components including the system memory 120 to the processing unit 110. The system bus 130 may be any of several types of bus structures including a memory bus or memory controller, a peripheral bus, and a local bus using any of a variety of bus architectures. The system memory 120 may include read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also may include a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. These drives and their associated computer-readable media provide nonvolatile storage of computer-readable instructions, data structures, program modules, and other data for the personal computer 100. It will be appreciated by those skilled in the art that other types of computer-readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140, or RAM 150, including an operating system 195, one or more application programs 196, other program modules 197, and program data 198. A user can enter commands and information into the computer 100 through input devices, such as a keyboard 101 and pointing device 102 (such as a mouse). Other input devices (not shown) may include a microphone, joystick, game pad, satellite dish, scanner, or the like. These and other input devices are often connected to the processing unit 110 through a serial port interface 106 that is coupled to the system bus 130, but they also may be connected by other interfaces, such as a parallel port, game port, a universal serial bus (USB), and the like. Further still, these devices may be coupled directly to the system bus 130 via an appropriate interface (not shown).

A monitor 107 or other type of display device also may be connected to the system bus 130 via an interface, such as a video adapter 108. In addition to the monitor 107, personal computers typically include other peripheral output devices (not shown), such as speakers and printers. In one example, a pen digitizer 165 and accompanying pen or stylus 166 are provided in order to digitally capture freehand input. Although a connection between the pen digitizer 165 and the serial port interface 106 is shown in FIG. 9, in practice, the pen digitizer 165 may be directly coupled to the processing unit 110, or it may be coupled to the processing unit 110 in any suitable manner, such as via a parallel port or another interface and the system bus 130 as is known in the art. Furthermore, although the digitizer 165 is shown apart from the monitor 107 in FIG. 9, the usable input area of the digitizer 165 may be co-extensive with the display area of the monitor 107. Further still, the digitizer 165 may be integrated in the monitor 107, or it may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and it typically includes many or all of the elements described above relative to the computer 100, although only a memory storage device 111 has been illustrated in FIG. 9. The logical connections depicted in FIG. 9 include a local area network (LAN) 112 and a wide area network (WAN) 113. Such networking environments are commonplace in offices, enterprise-wide computer networks, intranets, and the Internet, using both wired and wireless connections.

When used in a LAN networking environment, the computer 100 is connected to the local area network 112 through a network interface or adapter 114. When used in a WAN networking environment, the personal computer 100 typically includes a modem 115 or other means for establishing communications over the wide area network 113, such as the Internet. The modem 115, which may be internal or external to the computer 100, may be connected to the system bus 130 via the serial port interface 106. In a networked environment, program modules depicted relative to the personal computer 100, or portions thereof, may be stored in the remote memory storage device.

It will be appreciated that the network connections shown are examples and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Although the FIG. 9 environment shows an example environment, it will be understood that other computing environments may also be used. For example, one or more examples of the present invention may use an environment having fewer than all of the various aspects shown in FIG. 9 and described above, and these aspects may appear in various combinations and subcombinations that will be apparent to one of ordinary skill.

FIG. 10 illustrates a pen-based personal computer (PC) 201 that can be used in accordance with various aspects of the present invention. Any or all of the features, subsystems, and functions in the system of FIG. 9 can be included in the computer of FIG. 10. The pen-based personal computer system 201 includes a large display surface 202, e.g., a digitizing flat panel display, preferably, a liquid crystal display (LCD) screen, on which a plurality of windows 203 is displayed. Using stylus 204, a user can select, highlight, and write on the digitizing display area. Examples of suitable digitizing display panels include electromagnetic pen digitizers, such as pen digitizers available from Mutoh Co. or Wacom Technology Co. Other types of pen digitizers, e.g., optical digitizers, may also be used. The pen-based computing system 201 interprets gestures made using stylus 204 in order to manipulate data, enter text, and execute conventional computer application tasks, such as creating, editing, and modifying spreadsheets, word processing programs, and the like.

The stylus 204 may be equipped with buttons or other features to augment its capabilities. In one example, a stylus 204 could be implemented as a “pencil” or “pen”, in which one end constitutes a writing portion and the other end constitutes an “eraser” end, and which, when moved across the display, indicates portions of electronic ink on the display that are to be erased. Other types of input devices, such as a mouse, trackball, or the like also could be used. Additionally, a user's own finger could be used for selecting or indicating portions of the displayed image on a touch-sensitive or proximity-sensitive display. Consequently, the term “user input device,” as used herein, is intended to have a broad definition and encompasses many variations on well-known input devices.

V. Conclusion

The illustrated examples of the invention enable ink repurposing through the use of an Edit button 400 provided in a toolbar 304. Of course, this is just an example of one way in which aspects of the present invention may be used or activated. Any other suitable ways of activating the systems and methods of the invention may be used without departing from the invention. For example, selecting ink text may automatically activate a menu from which a user may convert the selected text for use in another application program. As another example, “right” clicking or tapping selected text may activate a “convert to” menu. As yet another alternative, the selected text may be dragged into the desired application program, e.g., dragged into a listing on a toolbar. Other ways also are possible.

Various examples of the present invention have been described above, and it will be understood by those of ordinary skill that the present invention includes within its scope all combinations and subcombinations of these examples. Additionally, those skilled in the art will recognize that the above examples simply exemplify the invention. Various changes and modifications may be made without departing from the spirit and scope of the invention, as defined in the appended claims.

1. A system, comprising:
a first application program that includes electronic ink data; and
a processor that introduces a data set relating to at least a portion of the electronic ink data into a second application program that is different from the first application program.

2. A system according to claim 1, wherein the data set introduced into the second application program includes the portion of the electronic ink data.

3. A system according to claim 1, wherein the data set introduced into the second application program includes data representing machine-generated text generated based on the portion of the electronic ink data.

4. A system according to claim 1, wherein the second application program is an email application program.

5. A system according to claim 4, wherein the data set introduced into the second application program is introduced into a message field of an outgoing email message generated by the email application program.

6. A system according to claim 1, wherein the second application program is an electronic calendar system.

7. A system according to claim 1, wherein the second application program is an electronic address book.

8. A system according to claim 1, wherein the second application program is an electronic task manager.

9. A system according to claim 1, wherein the system displays a list of target second application programs to which the data set corresponding to the portion of the electronic ink may be introduced.

10. A system according to claim 1, further comprising:
a target application program input through which the system receives a selection of the second application program.

11. A system according to claim 1, further comprising:
a handwriting recognizer for converting the portion of the electronic ink data to machine-generated text, wherein the data set introduced into the second application program provides access to the machine-generated text.

12. A system according to claim 1, further comprising:
an ink selection input through which the system receives an indication of the portion of the electronic ink to be used in generating the data set.

13. A system according to claim 1, wherein the first application program receives strokes as user input and generates electronic ink data from the user input.

14. A method, comprising:
receiving electronic ink data in a first application program; and
introducing a data set relating to at least a portion of the electronic ink data into a second application program that is different from the first application program.

15. A method according to claim 14, wherein the data set introduced into the second application program includes the portion of the electronic ink data.

16. A method according to claim 14, wherein the data set introduced into the second application program includes data representing machine-generated text generated based on the portion of the electronic ink data.

17. A method according to claim 14, wherein the second application program is an email application program.

18. A method according to claim 17, wherein the data set introduced into the second application program is introduced into a message field of an outgoing email message generated by the email application program.

19. A method according to claim 14, wherein the second application program is an electronic calendar system.

20. A method according to claim 14, wherein the second application program is an electronic address book.

21. A method according to claim 14, wherein the second application program is an electronic task manager.

22. A method according to claim 14, further comprising:
displaying a list of target second application programs to which the data set corresponding to the portion of the electronic ink may be introduced.

23. A method according to claim 14, further comprising:
receiving input indicating a selection of the second application program.

24. A method according to claim 14, further comprising:
converting the portion of the electronic ink data to machine-generated text, wherein the data set introduced into the second application program provides access to the machine-generated text.

25. A method according to claim 14, further comprising:
receiving input selecting the portion of the electronic ink to be used in generating the data set.

26. A method according to claim 14, wherein the first application program receives strokes as user input and generates electronic ink data from the user input.

27. A computer-readable medium including computer-executable instructions for performing a method, comprising:
receiving electronic ink data in a first application program; and
introducing a data set relating to at least a portion of the electronic ink data into a second application program that is different from the first application program.

28. A computer-readable medium according to claim 27, wherein, in the method, the data set introduced into the second application program includes the portion of the electronic ink data.

29. A computer-readable medium according to claim 27, wherein, in the method, the data set introduced into the second application program includes data representing machine-generated text generated based on the portion of the electronic ink data.

30. A computer-readable medium according to claim 27, wherein the second application program is an email application program.

31. A computer-readable medium according to claim 30, wherein, in the method, the data set introduced into the second application program is introduced into a message field of an outgoing email message generated by the email application program.

32. A computer-readable medium according to claim 27, wherein the second application program is an electronic calendar system.

33. A computer-readable medium according to claim 27, wherein the second application program is an electronic address book.

34. A computer-readable medium according to claim 27, wherein the second application program is an electronic task manager.

35. A computer-readable medium according to claim 27, wherein the method further includes displaying a list of target second application programs to which the data set corresponding to the portion of the electronic ink may be introduced.

36. A computer-readable medium according to claim 27, wherein the method further includes receiving input indicating a selection of the second application program.

37. A computer-readable medium according to claim 27, wherein the method further includes converting the portion of the electronic ink data to machine-generated text, wherein the data set introduced into the second application program provides access to the machine-generated text.

38. A computer-readable medium according to claim 27, wherein the method further includes receiving input selecting the portion of the electronic ink to be used in generating the data set.

39. A computer-readable medium according to claim 27, wherein the first application program receives strokes as user input and generates electronic ink data from the user input.

40. A system comprising:
an input that receives a selection of a data set contained in a source application program, wherein the data set includes electronic ink data;
a processor that inserts target data based on the data set into a target application program, wherein the target application program is different from the source application program, wherein the processor further associates additional information with the target data or the data set, wherein the additional information includes at least one member selected from the group of: data providing a link from the target data to the data set; data providing a link from the data set to the target data; data identifying a source from which the target data was obtained; data identifying a target to which the target data was sent; data representing related documents associated with the target data; data representing related documents associated with the data set; data representing factual information associated with the target data; and data representing factual information associated with the data set.

41. A system according to claim 40, wherein the additional information is in the form of metadata.

42. A system according to claim 40, wherein the additional information includes data that is user searchable.

43. A system according to claim 40, wherein the additional information includes both data providing the link from the target data to the data set and data providing the link from the data set to the target data.

44. A method comprising:
inserting target data based on a data set contained in a source application program into a target application program, wherein the data set includes electronic ink data and wherein the target application program is different from the source application program;
associating additional information with the target data or the data set, wherein the additional information includes at least one member selected from the group of: data providing a link from the target data to the data set; data providing a link from the data set to the target data; data identifying a source from which the target data was obtained; data identifying a target to which the target data was sent; data representing related documents associated with the target data; data representing related documents associated with the data set; data representing factual information associated with the target data; and data representing factual information associated with the data set.

45. A method according to claim 44, wherein the additional information is in the form of metadata.

46. A method according to claim 44, wherein the additional information includes data that is user searchable.

47. A method according to claim 44, wherein the additional information includes both data providing the link from the target data to the data set and data providing the link from the data set to the target data.

48. A computer-readable medium including computer-executable instructions stored thereon for performing a method comprising:
inserting target data based on a data set contained in a source application program into a target application program, wherein the data set includes electronic ink data and wherein the target application program is different from the source application program;
associating additional information with the target data or the data set, wherein the additional information includes at least one member selected from the group of: data providing a link from the target data to the data set; data providing a link from the data set to the target data; data identifying a source from which the target data was obtained; data identifying a target to which the target data was sent; data representing related documents associated with the target data; data representing related documents associated with the data set; data representing factual information associated with the target data; and data representing factual information associated with the data set.

49. A computer-readable medium according to claim 48, wherein the additional information is in the form of metadata.

50. A computer-readable medium according to claim 48, wherein the additional information includes data that is user searchable.

51. A computer-readable medium according to claim 48, wherein the additional information includes both data providing the link from the target data to the data set and data providing the link from the data set to the target data.
